(19) United States
(12) Patent Application Publication
(10) Pub. No.: US 2016/0328725 A1
(43) Pub. Date: Nov. 10, 2016

(54) SYSTEMS AND METHODS FOR PRESENTING STORE SALES DATA TO A MOBILE ELECTRONIC DEVICE

(71) Applicant: Wal-Mart Stores, Inc., Bentonville, AR (US)

(72) Inventors: Zulfiqar Ali Paracha, Bentonville, AR (US); Joshua David Osmon, Bentonville, AR (US); Rachel Marie Pfleging, Bentonville, AR (US); Brian Casey Harrison, Little Rock, AR (US); William Robert Piech, Rogers, AR (US); Mahesh Sundar Thangaraj, Centerton, AR (US); Brian Dewayne Burge, Centerton, AR (US); Anthony William Helms, Bentonville, AR (US); Derric D'souza, Bentonville, AR (US); Larry Michael Tyler, Wentzville, MO (US); Michael Andrew Budell Fischer, Bentonville, AR (US)

(21) Appl. No.: 15/148,280

(22) Filed: May 6, 2016

Related U.S. Application Data
(60) Provisional application No. 62/158,101, filed on May 7, 2015.

(51) Int. Cl. G06Q 30/02; G06Q 20/32

(52) U.S. Cl. CPC G06Q 30/0202; G06Q 20/322; G06Q 30/0201

(57) ABSTRACT

Provided are a computer-implemented system and method for generating real-time store sales data. Sales data is stored regarding items located at multiple retail stores. A user may enter a store with a mobile electronic device. The mobile electronic device accesses sales data pertaining to sales of at least one preselected target item in each of the multiple stores. Generated from the sales data is a sales analysis report in real-time on the mobile electronic device. The sales data of the store accessed in real-time is compared with comparable sales data of other stores.

### RELATED APPLICATION

This application claims priority to U.S. Provisional Application Ser. No. 62/158,101, filed on May 7, 2015 entitled “Systems and Methods for Presenting Store Sales Data to a Mobile Electronic Device”, the entirety of which is incorporated by reference herein.

### FIELD

The present concepts relate generally to mobile electronic device applications, and more specifically, to systems and methods for providing sales data in real-time to a mobile electronic device.

### BACKGROUND

Modern retail establishments such as “superstores” or other retailers carry extensive inventories of different products for sale. A retailer typically organizes the products they carry into distinct groups, categories, and/or departments, i.e. produce, paper products, health and beauty aids, and so on. From a financial perspective, each department may be run like a small business. In doing so, the retailer will often monitor group, category, and/or department sales and profit margins.

### BRIEF SUMMARY

In one aspect, provided is a computer-implemented method for generating real-time store sales data. In the method, sales data is stored regarding items located at multiple retail stores. A user may enter a store with a mobile electronic device. The mobile electronic device accesses sales data pertaining to sales of at least one preselected target item in each of the multiple stores. Generated from the sales data is a sales analysis report in real-time on the mobile electronic device. The sales data of the store accessed in real-time compared with comparable sales data of other stores.

In some embodiments, the computer-implemented method further comprises displaying, at a display of the mobile electronic device, the sales data in a format that includes at least one of top selling items, top profit items, and top volume items.

In some embodiments, the real-time sales data includes store level or department level sales data, and further identifies highest revenue, profit, or volume items at the store or department.

In some embodiments, sales data of a product is accessed by the mobile electronic device at a region of the store proximal to the product.

In some embodiments, the computer-implemented method further comprises comparing current store sales against that of other stores within a same market.

in some embodiments, the sales data is updated at the mobile electronic device on a predetermined periodic basis.

In another aspect, provided is a system for generating real-time store sales data, comprising a hardware computer processor that provides a store touring application to a mobile electronic device; a database at the store that includes sales data; and a service layer server that receives the sales data from the database in response to a request from the store touring application executed at the mobile electronic device.

In some embodiments, the hardware computer processor updates the store touring application at the mobile electronic device.

In some embodiments, the system further comprises a server that receives a request for sales data from a plurality of stores for comparing the sales data of the store with comparable sales data of other stores, and routes the request to a database each store that includes the sales data for each store.

In some embodiments, the sales data is updated at the mobile electronic device on a predetermined periodic basis.

In some embodiments, the sales data includes store level or department level sales data provided in real-time or near real-time, and includes at least one of highest revenue, profit, or volume items at the store or department.

In some embodiments, sales data of a product is accessed by the mobile electronic device at a region of the store proximal to the product.

In some embodiments, the system further comprises a processor that compares current store sales against that of other stores within a same market.

In some embodiments, the service layer server generates a call to the database of the store, processes response data from the database, and provides the response data to the store touring application on the mobile electronic device.

In some embodiments, the response data includes data regarding at least one of a count of stores, a list of departments for a given store, sales per department for a particular period of time, top categories, forecasted sales for an upcoming period of time, and sales by department for all stores within the market of the current store.

In another aspect, provided is a system for generating real-time store sales data, comprising: means for providing a store touring application to a mobile electronic device; means for storing sales data corresponding to the store; and means for receiving the stored sales data in response to a request from the store touring application executed at the mobile electronic device, the sales data generated from a sales analysis report in real-time on the mobile electronic device.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an environment in which embodiments can be practiced.

FIG. 2 is flow diagram of a store touring application process, in accordance with some embodiments.

FIG. 3 is a flow diagram of a method for providing sales data in real-time to a mobile smart device, in accordance with some embodiments.

FIGS. 4-18 are screenshot views of a user interface performing various steps of a process related to the presentation of sales data, in accordance with some embodiments.

### DETAILED DESCRIPTION

In order to bolster sales or better understand the financial performance of a product or group, retail sales representatives, financial analysts, executives, or other store employees may tour a store to determine how well or poorly a group, category, and/or department is performing. However, the related volume of analytic data is often extremely difficult to sort through, track, and manage, which may lead to an economic impact on sales due to inventory or spending issues. Paper reports are often generated for the manager's benefit to review top selling items, sales trends, and so on, but are not provided in real-time, and are limited in usefulness with respect to the quality of the information.

In brief overview, systems and methods are provided that allow a user to access real-time sales data of a store using a mobile application stored in memory and executed by a mobile electronic device processor. Real-time sales data may be readily displayed in different user-defined formats, for example, top selling items, top profit items, top categories, and so on, which may be triggered by the location of the mobile electronic device relative to the products of which the sales data pertains. In some embodiments, sales data from the store where the mobile electronic device is located is compared to sales data of other stores. Accordingly, corporate level information can be displayed, for example, top selling items or top profit items across some or all stores of the company, or stores within a particular region or market.

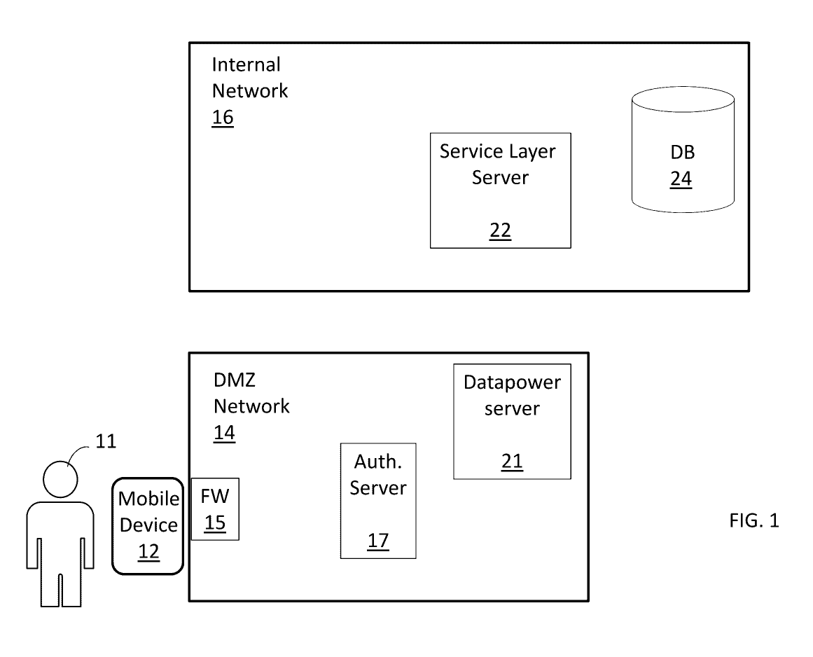

FIG. 1 is a diagram of an environment in which embodiments can be practiced.

A user 11 such as a store manager with a mobile electronic device 12 can receive sales data at the device 12 in real-time while touring a retail establishment. The mobile electronic device 12 can be a personal digital assistant (PDA), smartphone, laptop computer, or other handheld or portable electronic device. The sales data may be updated on a predetermined, periodic basis, for example, hourly. The sales data can be generated from raw data and stored by an independent well-known process, technique, system, or device. For example, a financial system may generate a report that includes sales revenues broken down by each product sold at the store during the previous day.

The mobile electronic device 12 can include, but not be limited to, a display, a memory, a processor for executing code related to received store information stored at the memory, and a global positioning system (GPS). The display includes a user interface that permits the user 11 to enter data into the mobile electronic device 12 and to display data received by the device 12. The display can include at keyboard, touchscreen, speaker, and the like. The memory can store operating system software and/or instructions related to an application that processes sales data for display in real-time or near real-time for use by the viewer 11 in accordance with embodiments, for example, described herein.

The DMZ network 14 may include, but not be limited to, an authorization server 17 and a cluster manager 18 that expose the store's external facing services to the Internet or other untrusted network. The DMZ network 14 includes a firewall 15 or other security devices for preventing external attacks on hosts or the like inside the store internal computer network 16. The DMZ network 14 may provide access to a single store, or multiple stores, for example, to multiple databases, each including sales data for a given store.

The authorization server 17 and/or other device manager may authenticate credentials provided between the mobile electronic device 12 and the DMZ network 14. After the credentials are authenticated, the application for processing sales data can be auto-downloaded from an application database or other storage device to the mobile electronic device 12.

A server 21, for example, a DataPower® server, in communication with elements of the internal network 16 and/or DMZ network 14 can route the calls, which includes sales data, to each store identified, for example, all stores including a particular product, or all stores in a same market, one of which may be the store having the internal network 16.

The store internal network 16 may pertain to a particular store. The internal network 16 may include a service layer server 22 and a database (DB) 24. In other embodiments, a single database is structured to include sales data for different stores. Other network devices including routers, switches, load balancers, firewalls, servers, and so on can also be part of the internal network 16 for establishing communications between the service layer server 22 and/or database 24 and the mobile electronic device 12. The service layer server 22 generates database calls to the database 24, processes the received data, and outputs the response data to a store touring application, also referred to as a sales application or “sales app,” stored and executed at the mobile electronic device 12. In doing so, the service layer server 22 can create a socket connection or the like for transmitting a payload through the socket or the like to invoke a service-related communication between the database 24, the service layer server 22, and the mobile electronic device 12 at the store.

The database 24 includes sales data for the store and/or other stores. The sales data can be organized in the database 24 according to department, store, product type, volume, or other relevant structure which permits the data to be processed to generate a report for analysis or other use by the user 11.

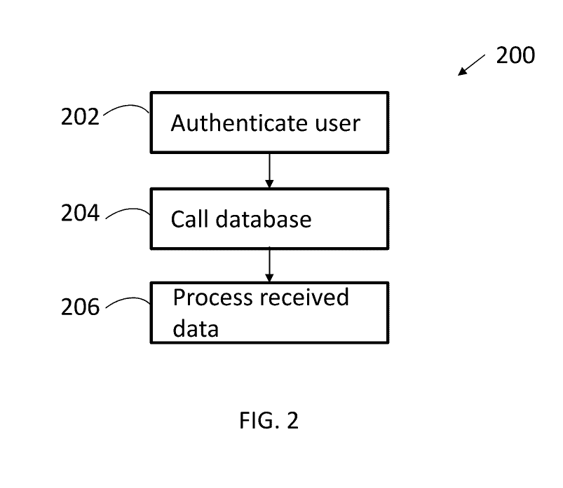

FIG. 2 is flow diagram of a store touring application process 200, in accordance with some embodiments. In describing the process 200, reference is made to elements of FIG. 1.

At block 202, the user 11 is authenticated. This is achieved by the mobile electronic device 12 logging into the server at the DMZ network 14, for example, using an Airwatch® profile or the like along with proper active directory credentials, for example, entered in an Airwatch® agent or the like at the mobile electronic device 12 for auto login. A store touring application or related sales application can be downloaded from a device manager (not shown) and/or database 24 at the internal network 16. During authorization, a determination can be made whether the application loaded at the mobile electronic device 12 is a correct or recent version, and automatically update the version if the application is out-of-date or incorrect.

At block 204, the store touring application provides information to a mobile electronic device user touring a store to determine how well or poorly a group, category, and/or department is performing. In doing so, the store touring application on the mobile electronic device 12 calls a service, for example, at the DMZ network 14. The service layer server 22 makes a database call to the store, and processes response data from the database 24, and provides the response data to the touring application on the mobile electronic device 12. The response data may include web service calls provided for the store touring application, for example, providing and/or updating a count of stores that may be accessed through the store touring application for a given date by the user. Other web service calls may relate to but not be limited to, a list of departments for a given store, sales per department for a particular period of time, e.g., today or yesterday, top categories, e.g., for the current week, forecasted sales for an upcoming period of time, sales by department for all stores within the market of the current store, and so on.

At block 206, the received response data is processed at the mobile electronic device 12 to generate the real-time sales data, for example, described in embodiments herein.

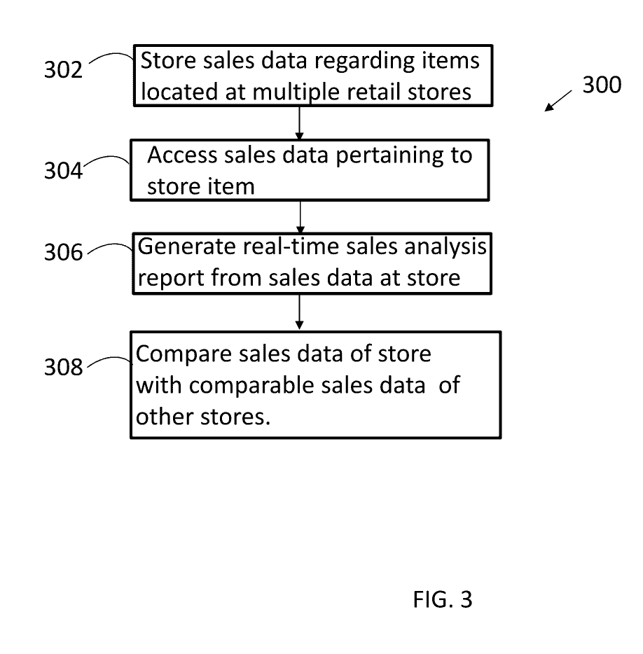

FIG. 3 is a flow diagram of a method 300 for providing sales data in real-time to a mobile smart device, in accordance with some embodiments. In describing the method 300, reference is made to elements of FIG. 1. Some or all of the method 300 can be performed in hardware processors, for example, of the mobile electronic device 12, and can be part of one or more special-purpose computers, such that execute computer program instructions which implement one or more functions and operations of the mobile electronic device 12 and/or hardware components of the internal network 16 and/or DMZ network 14 of FIG. 1.

At block 302, sales data is stored at the database 24 regarding items located at multiple retail stores. The server 21 can route a service call related to the exchange of the sales data to each store in a predefined list, for example, each store in a particular geography or market such as the store corresponding to the internal network 16 shown in FIG. 1. Sales data for a given store is retrieved from the store, for example, from database 24, in response to a request made by the store touring application on the mobile electronic device 12.

At block 304, sales data regarding a store item is accessed by the mobile smart device. In some embodiments, sales data for an item sold at each of a plurality of stores is accessed, for example, from database 24 of a particular store. The mobile electronic device accesses sales data by the user touring the store with the mobile electronic device to a department, aisle, or other region of the store where an item of interest is located. When the mobile electronic device is at or near the item of interest, the sales data regarding the item is retrieved in response to a user request, for example, selecting a department of interest at the store where the user is currently located.

At block 306, real-time sales analysis reports or the like can be generated from sales data at one or more stores.

At block 308, the sales data of the store can be compared with comparable sales data of other stores. Each store may have an internal network similar to or the same as internal network 16 shown in FIG. 1. Here, sales data can be retrieved from a database 24 of each store as part of the comparison.

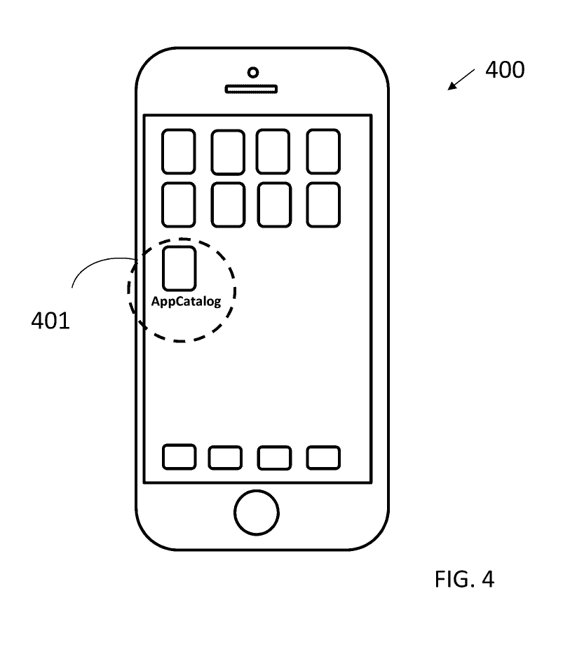

FIGS. 4 -18 are screenshots of a user interface 400 performing various steps of a process related to the presentation of sales data, in accordance with some embodiments.

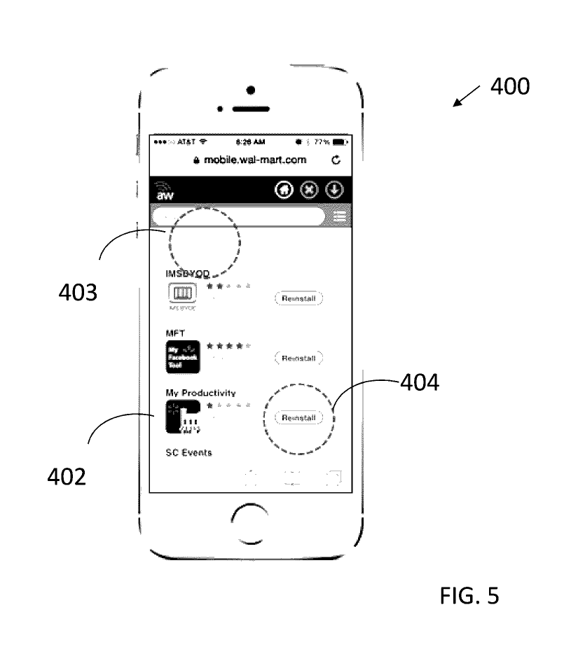

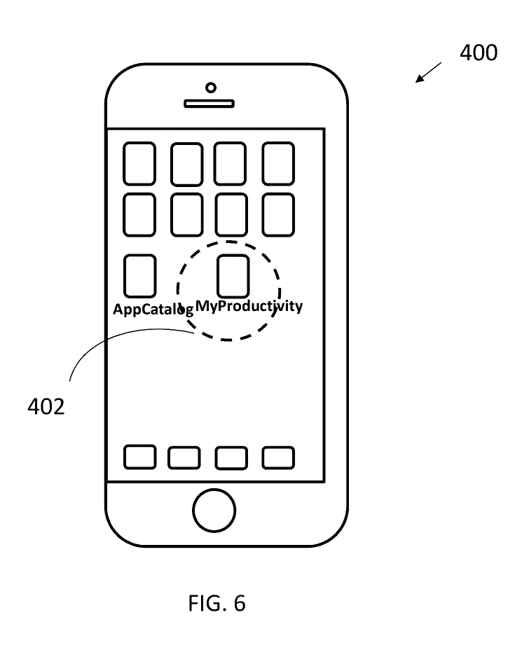

At FIG. 4, the user interface 400 displays an application catalog icon 401 entitled “AppCatalog” which, when executed, as shown in FIGS. 5 and 6, downloads a “MyProductivity” application, shown as an icon 402. In doing so, a user can select an “Internal” tab 403, then a “Reinstall” button 404 at the user interface 400.

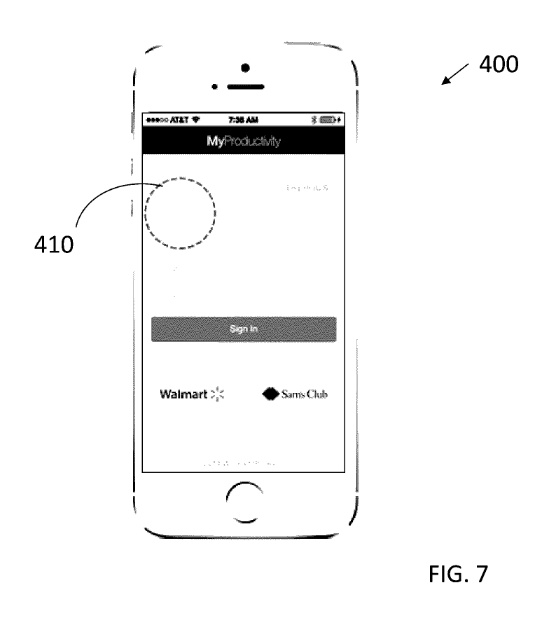

At FIG. 7, a user can enter security information 410 for authentication purposes, such as a user identification (ID) and password.

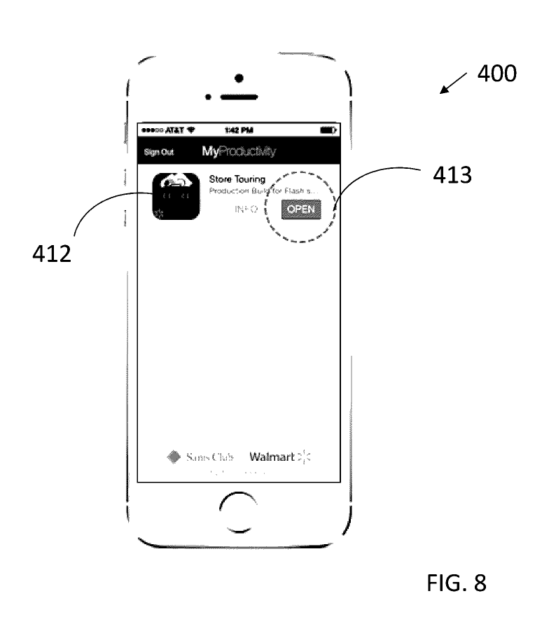

At FIG. 8, a user can activate a store touring application 412, for example, by selecting an “Open” button 413. The store touring application 412 is resident on the mobile electronic device 12, and can be downloaded to the device 12 and/or updated according to embodiments described herein.

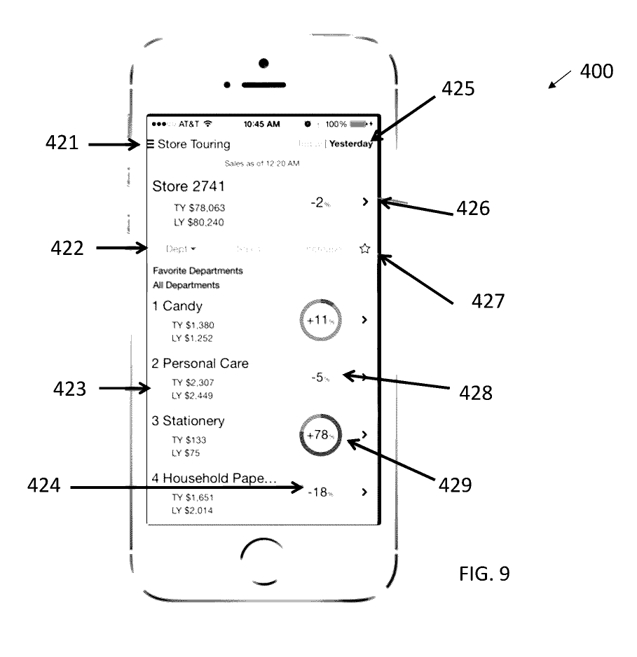

At FIG. 9, features of the store touring application 412 are displayed. For example, sales data such as sales revenue, top selling items per department, percentage change in sales, and so on may displayed. At icon 421, the user is provided an option to refresh the displayed data.

At display field 422, a user may sort the displayed data, for example, according to department (Dept.), sales value, percentage increase in sales, and so on.

At display field 423, displayed sales data may be updated automatically on a predetermined basis, for example, hourly. The application may be configured to automatically generate a request on a predetermined basis, and/or a timer device can deliver the data on a user-defined or hardcoded basis.

At display field 424, a percentage indicator is displayed, indicating a percentage increase or decrease relative to a previous time period. As shown in FIG. 9, sales decreased by 18% as compared to the previous year.

At display field 425, the user can toggle between different time periods, for example, today or yesterday to view data corresponding to the selected time period.

At display field 426, a user may swipe this region of the user interface 4000 to receive more options which may be displayed, for example, department-level or store-level information.

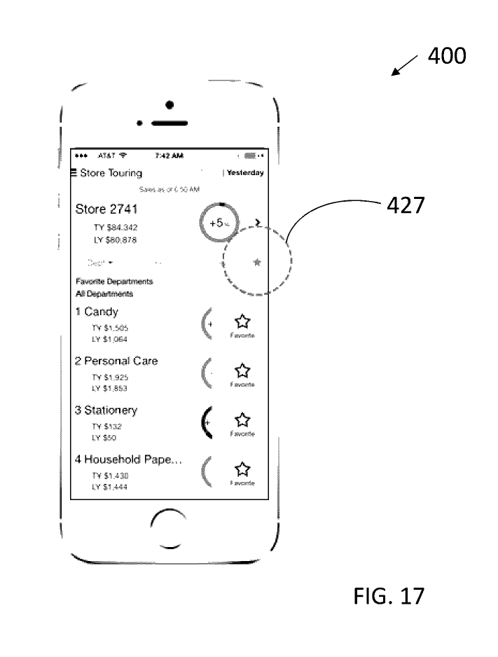

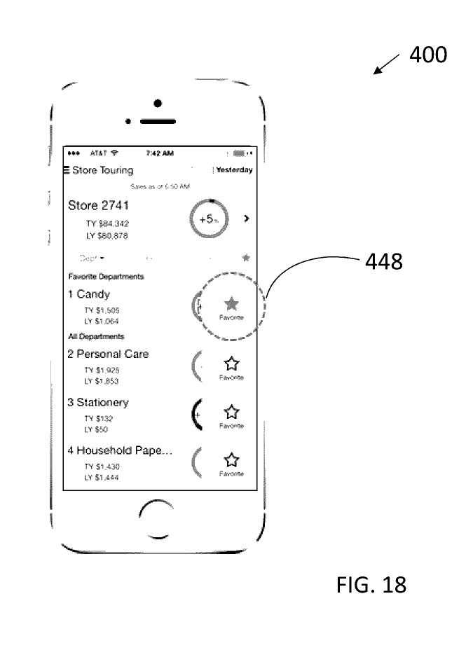

Icon 427 may be selected to permit the user to identify a “favorite category” such as “Department,” which may simplify the user experience with respect to selecting this category for viewing its corresponding data (see FIG. 17). As shown in FIG. 18, a user can select a “Favorite” button 448 corresponding to a favorite department, e.g., “Candy”.

At display fields 428 and 429, a circle about a percentage indicator can be displayed according to a color indicating whether sales are decreased (circle 428) or increased (circle 429).

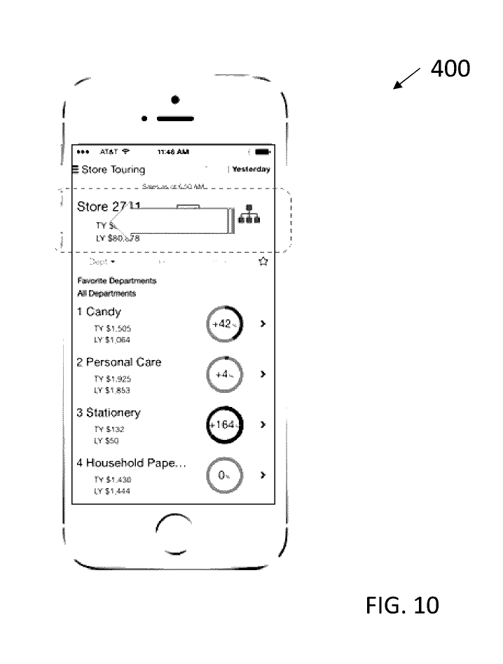

At FIG. 10, illustrated is a feature where a user can swipe or select a “store level”, permitting access to the store's top categories, permitting the user to view how the current store ranks in the store's market.

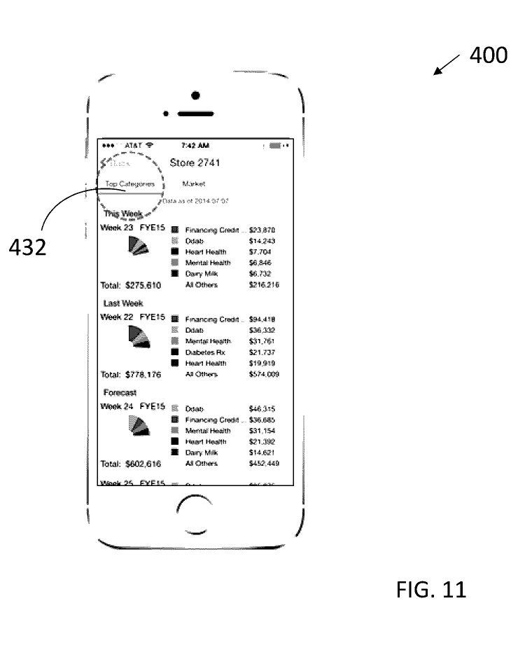

At FIG. 11, illustrated is a feature where a user can select “Top Categories” 432 from the user interface 400, which allows the user to see top categories at a store level. A user can identify those categories that comprise a majority of the sales revenues at the store. The data can be displayed for each week, or other visual format preferred by the user.

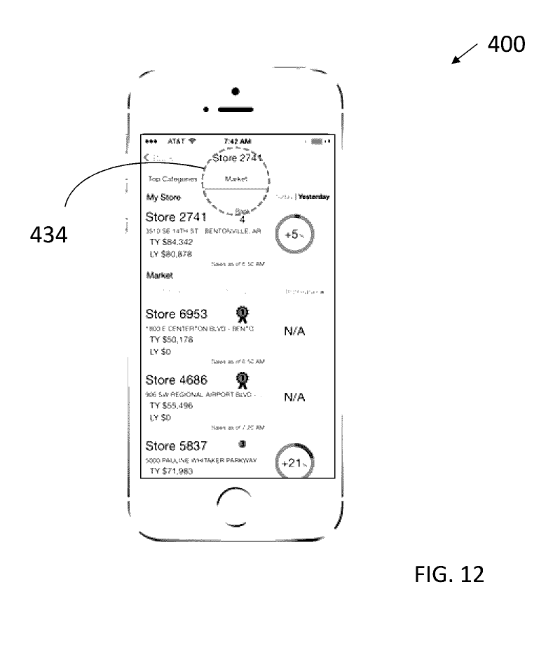

At FIG. 12, illustrated is a feature where a user can select “Market” 434 from the user interface 400, which allows the user to view how the store ranks in in the store's market. Here, data from multiple stores may be retrieved, processed, and displayed, so that the user can compare the sales, top items, and so on of the store at which the user is current located (e.g., 2741) to other stores in the market. The display can change based on the user's location. For example, the user may be at store 6953, whereby sales data related to store 6953 may be displayed under “My Store”.

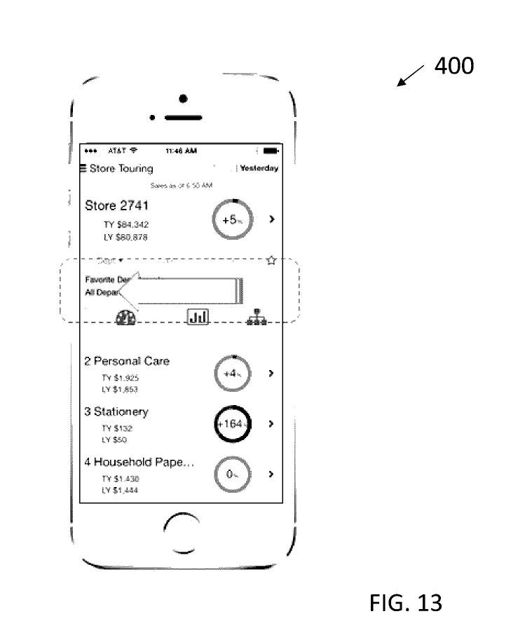

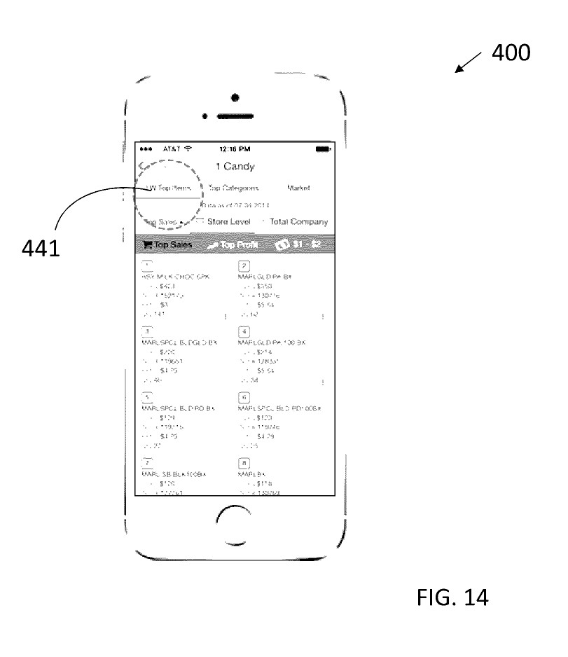

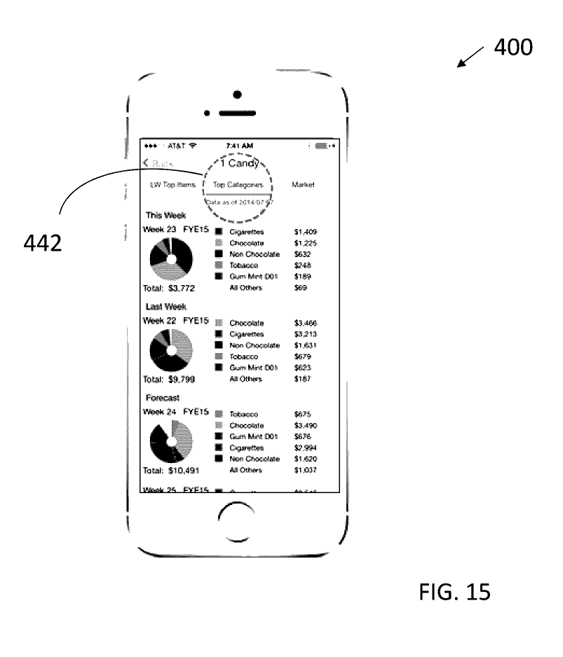

At FIG. 13, illustrated is a feature where a user can swipe or select “Top Items,” “Top Categories,” and so on, permitting the user to view data such as “Top Items” 441 having a predetermined sales value, e.g., $1-$2 at a store level or a company level as shown in FIG. 14, or “Top Categories” 442 at a department level as shown in FIG. 15.

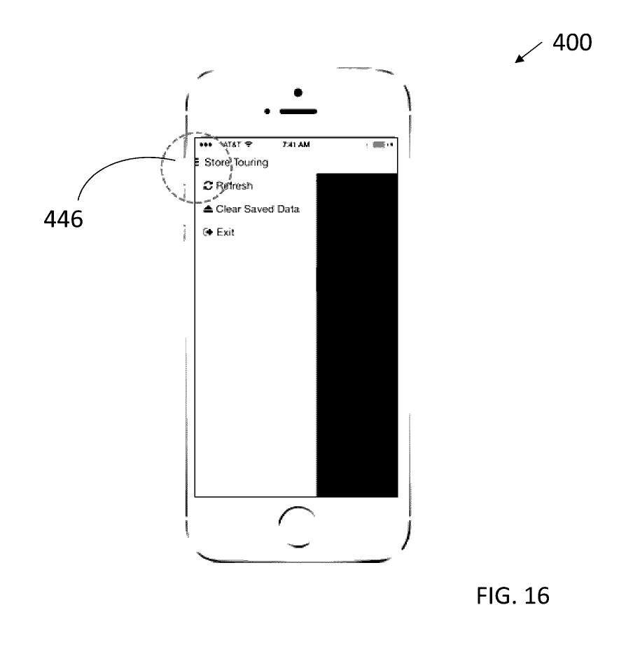

At FIG. 16, illustrated is a feature where a user can select a refresh button 446 to update displayed information on the user interface 400.

As will be appreciated by one skilled in the art, concepts may be embodied as a device, system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Computer program code for carrying out operations for the concepts may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Concepts are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While concepts have been shown and described with reference to specific preferred embodiments, it should be understood by those skilled in the art that various changes in form and detail may be made therein without departing from the spirit and scope as defined by the following claims.

What is claimed is:

1. A computer-implemented method for generating real-time store sales data, comprising:
storing sales data regarding items located at multiple retail stores;
entering a store with a mobile electronic device;
accessing by the mobile electronic device sales data pertaining to sales of at least one preselected target item in each of the multiple stores;
generating from the sales data a sales analysis report in real-time on the mobile electronic device;
comparing the sales data of the store accessed in real-time with comparable sales data of other stores.

2. The computer-implemented method of claim 1, further comprising:
displaying, at a display of the mobile electronic device, the sales data in a format that includes at least one of top selling items, top profit items, and top volume items.

3. The computer-implemented method of claim 1, wherein the real-time sales data includes store level or department level sales data, and further identifies highest revenue, profit, or volume items at the store or department.

4. The computer-implemented method of claim 1, wherein sales data of a product is accessed by the mobile electronic device at a region of the store proximal to the product.

5. The computer-implemented method of claim 1, further comprising comparing current store sales against that of other stores within a same market.

6. The computer-implemented method of claim 1, wherein the sales data is updated at the mobile electronic device on a predetermined periodic basis.

7. A system for generating real-time store sales data, comprising:
a hardware computer processor that provides a store touring application to a mobile electronic device;
a database at the store that includes sales data; and
a service layer server that receives the sales data from the database in response to a request from the store touring application executed at the mobile electronic device.

8. The system of claim 7, wherein the hardware computer processor updates the store touring application at the mobile electronic device.

9. The system of claim 7, further comprising a server that receives a request for sales data from a plurality of stores for comparing the sales data of the store with comparable sales data of other stores, and routes the request to a database each store that includes the sales data for each store.

10. The system of claim 7, wherein the sales data is updated at the mobile electronic device on a predetermined periodic basis.

11. The system of claim 7, wherein the sales data includes store level or department level sales data provided in real-time or near real-time, and includes at least one of highest revenue, profit, or volume items at the store or department.

12. The system of claim 7, wherein sales data of a product is accessed by the mobile electronic device at a region of the store proximal to the product.

13. The system of claim 7, further comprising comparing current store sales against that of other stores within a same market.

14. The system of claim 7, where in the service layer server generates a call to the database of the store, processes response data from the database, and provides the response data to the store touring application on the mobile electronic device.

15. The system of claim 14, wherein the response data includes data regarding at least one of a count of stores, a list of departments for a given store, sales per department for a particular period of time, top categories, forecasted sales for an upcoming period of time, and sales by department for all stores within the market of the current store.

16. A system for generating real-time store sales data, comprising:
means for providing a store touring application to a mobile electronic device;
means for storing sales data corresponding to the store; and
means for receiving the stored sales data in response to a request from the store touring application executed at the mobile electronic device, the sales data generated from a sales analysis report in real-time on the mobile electronic device.
